(19) United States
(12) Patent Application Publication
(10) Pub. No.: US 2015/0283743 A1
(43) Pub. Date: Oct. 8, 2015

(54) BASE MOLD AND METHOD OF FABRICATING MOLD

(71) Applicant: Electronics and Telecommunications Research Institute, Daejeon (KR)

(72) Inventors: Jong-Moon PARK, Daejeon (KR); Kunsik PARK, Daejeon (KR); Dong Suk JUN, Daejeon (KR); Seong Wook YOO, Daegu (KR); Sang Gi KIM, Daejeon (KR); Jin Ho LEE, Daejeon (KR)

(21) Appl. No.: 14/517,482

(22) Filed: Oct. 17, 2014

(30) Foreign Application Priority Data
Apr. 3, 2014 (KR) 10-2014-0039956

(51) Int. Cl. B29C 45/17

(52) U.S. Cl. CPC B29C 45/17; B29L 2031/757

(57) ABSTRACT

Provided is a method of fabricating a mold, the method including: forming a first preliminary layer and a second preliminary layer, which are spaced apart from each other and stacked on a substrate; forming a first pattern by patterning the first preliminary layer; forming a first spacer on both sidewalls of the first pattern;

forming a second pattern by etching the second preliminary layer by using the first spacer as an etching mask; forming a multilayer structure including the first pattern and the second pattern on the substrate by removing the first spacer; and forming a mold layer covering the multilayer structure.

### CROSS-REFERENCE TO RELATED APPLICATIONS

This U.S. non-provisional patent application claims priority under 35 U.S.C. §119 of Korean Patent Application No. 10-2014-0039956, filed on Apr. 3 2014, the entire contents of which are hereby incorporated by reference.

### BACKGROUND

The present disclosure herein relates to a base mold and a method of fabricating a mold, and more particularly, to a base mold and a method of fabricating a mold for plastic injection molding and structural color implementation using a semiconductor process.

Structural color means color not depending on dye and represented by the surface structure of an object and more particularly means color formed when light of a specific wavelength is reflected, absorbed, and interfered by a unique and uniform fine structure that the surface of an object has. Recently, researches that attempt to apply such a physical phenomenon to industries are conducted. In order to implement the structural color, pattern techniques of a nano structure need to be accompanied and for this, studies on imprint lithography and methods of depositing nano layers are reported. New materials by applying color mechanism of such structural color may be applied to real life, for example, fiber, body painting of a car, or a company logo displayed on an electronic product. That is, color is implemented using structural color without depending on chemical pigments and dyes and this has a great comparative advantage with respect to a typical color implementation technology, so that creating new market is expected.

In order to implement structural color, a grating pattern is injected on polymer or plastic, and as a previous step to this, a mold for injecting molding is fabricated. In order to fabricate such a mold, a nano pattern is formed by coating nano particles or through photolithography but this has difficulties in controlling the width, height, and interval of a pattern and especially, in forming a pattern of a multilayer structure.

### SUMMARY

The present disclosure provides a method of fabricating a mold for plastic injection molding and structural color implementation by forming multilayer structures having a grating pattern that is repeated periodically on a silicon substrate through a semiconductor process.

The present disclosure provides a base mold for providing the mold.

Embodiments of the inventive concept provide base molds including: a plurality of multilayer structures arranged to be spaced apart from each other in one direction on a substrate, wherein each of the multilayer structures includes first to nth patterns spaced apart from each other and sequentially stacked on the substrate; a width of the first pattern is I; a width of the nth pattern is (2n−1)×I; the nth pattern includes edge parts disposed at both sides of the n−1th pattern and exposed by the n−1th pattern; a width of a top surface of each of the edge parts is I; and the first pattern of any one multilayer structure is spaced by a P interval apart from the first pattern of adjacent another multilayer structure, wherein P is n×I×2 and n is an integer equal to or greater than 3.

In other embodiments of the inventive concept, methods of fabricating a mold include: forming a first preliminary layer, a second preliminary layer, and a third preliminary layer disposed between the substrate and the second preliminary layer and spaced apart from the first preliminary layer with the second preliminary layer therebetween, which are spaced apart from each other and stacked on a substrate; forming a first pattern by patterning the first preliminary layer; forming a first spacer on both sidewalls of the first pattern; forming a second pattern by etching the second preliminary layer by using the first spacer as an etching mask; forming a second spacer on both sides of the second pattern; forming a third pattern by etching the third preliminary layer by using the second spacer as an etching mask; forming a multilayer structure including the first pattern, the second pattern and the third pattern on the substrate by removing the first spacer and the second spacer simultaneously; and forming a mold layer covering the multilayer structure.

In other embodiments, a width of the first pattern may be I; a width of the second pattern may be 3×1; a width of the third pattern is 5×1; and the second pattern may include first edge parts disposed at both sides of the first pattern and exposed by the first pattern, the third pattern comprises second edge parts disposed at both sides of the second pattern and exposed by the second pattern, wherein a width of a top surface of each of the first edge parts and the second edge parts may be I.

In still other embodiments, the multilayer structure may be formed repeatedly and the first pattern may be spaced by a P interval apart from the first pattern of adjacent another multilayer structure, wherein P may be (n)×I×2, n=the number of stacked patterns.

In even other embodiments, the forming of the first, second and third preliminary layers may include additionally forming a first etch stop layer disposed on the first preliminary layer, a second etch stop layer disposed between the first preliminary layer and the second preliminary layer, and a third etch stop layer disposed between the second preliminary layer and the third preliminary layer.

In further embodiments, the substrate may be a silicon substrate having a (100) crystal structure and the forming of the first, second and third preliminary layers may include additionally forming a silicon etch stop layer on the substrate.

In still further embodiments, the forming of the first pattern may include: forming a photoresist pattern having a width of I on the uppermost part of the substrate in a direction where the first and second preliminary layers are disposed; and forming the first pattern by etching the first preliminary layer by using the photoresist pattern as an etching mask.

In even further embodiments, a width of the first pattern may be I, wherein the forming of the first spacer may include: depositing a first spacer layer on the first pattern at a thickness of 0.9I to 1.1I; and forming a first spacer on both sidewalls of the first pattern by etching the first spacer layer, the first spacer having a width of I in a direction vertical to a sidewall of the first pattern.

In even further embodiments, a width of the second pattern may be 3I, wherein the forming of the second spacer may include: depositing a second spacer layer on the first and second patterns at a thickness of 0.9I to 1.1I; and forming a second spacer on both sidewalls of the second pattern by etching the second spacer layer, the second spacer having a width of I in a direction vertical to a sidewall of the second pattern.

In yet further embodiments, the substrate may be a silicon substrate having a (100) crystal structure, wherein the forming of the mold layer may include:

forming a metal mold layer by introducing a metal to the multilayer structure; and removing the substrate and the multilayer structure.

In yet further embodiments, the substrate may be a silicon substrate having a (111) crystal structure, wherein the forming of the mold layer may include: forming a resin mold layer by introducing a thermosetting resin to the multilayer structure; and separating the substrate and the multilayer structure from the resin mold layer.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 illustrates a mask (a) for forming multilayer structures and a base mold (b) including three-story multilayer structures corresponding thereto;

FIGS. 2A to 2K are sectional views illustrating a method of fabricating a base mold including a substrate and multilayer structures according to an embodiment of the inventive concept;

FIGS. 3A to 3C are sectional views illustrating a method of fabricating a mold according to an embodiment of the inventive concept; and

FIGS. 4A to 4C are sectional views illustrating a method of fabricating a mold according to another embodiment of the inventive concept.

### DETAILED DESCRIPTION OF THE EMBODIMENTS

In order to fully understand the configurations and effects of the inventive concept, preferred embodiments of the inventive concept are described with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. Those skilled in the art understand that the concept of the inventive concept is applied to any suitable environment.

Terms used in this specification are used to describe embodiments and not intended to limit the inventive concept. In this specification, the terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

In the specification, it will be understood that when a layer (or film) is referred to as being ‘on’ another layer or substrate, it can be directly on the other layer or substrate, or intervening layers may also be present.

Also, though terms like a first, a second, and a third are used to describe various regions and layers in various embodiments of the inventive concept, the regions and the layers are not limited to these terms. These terms are used only to discriminate one region or layer from another region or layer. Therefore, a layer referred to as a first preliminary layer in one embodiment can be referred to as a second preliminary layer in another embodiment. An embodiment described and exemplified herein includes a complementary embodiment thereof. Like reference numerals refer to like elements throughout.

Unless otherwise defined, terms used in embodiments of the inventive concept may be interpreted as generally known meanings to those skilled in the art.

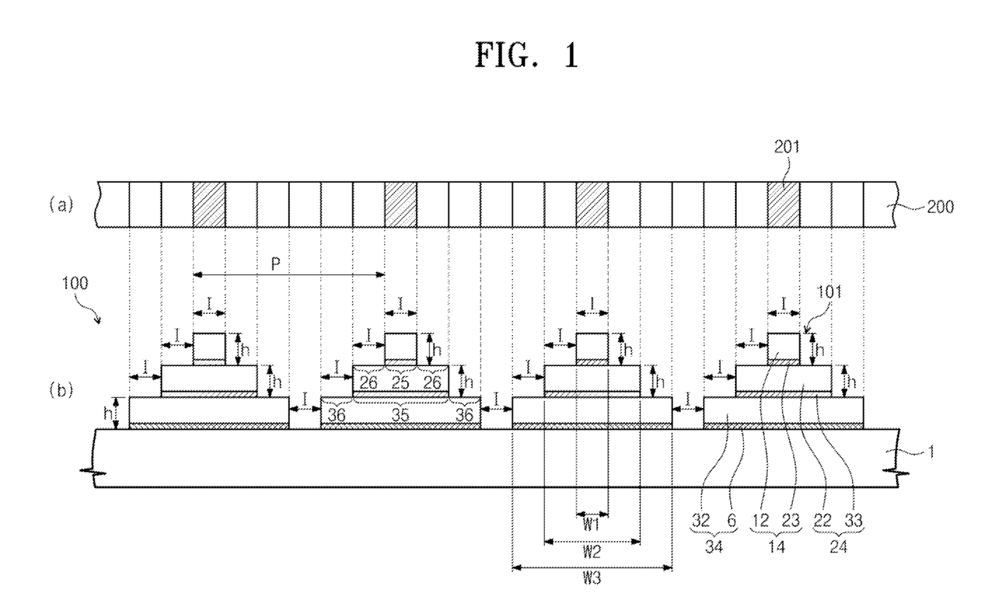

FIG. 1 illustrates a mask 200(a) for forming multilayer structures 101 and a base mold 100(b) including three-story multilayer structures 101 formed by using the mask 200(a). The mask 200 may include a plurality of chrome layers 201 and may define the standard of the multilayer structures 101 by adjusting a width I and an interval P of the chrome layers 201.

The base mold 100 for mold formation may be formed by using the mask 200. The base mold 100 may include a plurality of multilayer structures arranged to be spaced apart from each other in one direction on a substrate. Each of the multilayer structures 101 may include a first pattern 12, a second pattern 22, and a third pattern 32, which are spaced from each other on a substrate and sequentially stacked. In more detail, according to an embodiment of the inventive concept, each of the multilayer structures 101 may include a first layer 14, a second layer 24, and a third layer 34. The first layer 14 may include a first pattern 12 and a second etch stop pattern 23. The second layer 24 may include a second pattern 22 and a third etch stop pattern 33. The third layer 34 may include a third pattern 32 and a silicon etch top pattern 6. An interval P between the first patterns 12 of the multilayer structures 101 adjacent to each other may correspond to the interval P between chrome layers 201. The second pattern 22 may include a first center part 25 below the first pattern 12 and first edge parts 26 at both sides of the first pattern 12. The top surface of each of the first edge parts 26 may be exposed by the first pattern 12 and may have a width that is identical to the width W1 of the first pattern 12. The third pattern 32 may include a second center part 35 below the second pattern 22 and second edge parts 36 at both sides of the second pattern 22. The top surfaces of each of the second edge parts 36 may be exposed by the second pattern 22 and may have a width that is identical to the width W1 of the first pattern 12. Thus, the base mold 100 including the multilayer structures 101 where a uniform pattern is repeated from the plane viewpoint may be provided. The width W1 of the first pattern 12 may be identical to the width I of the chrome layer 201.

In more detail, each of the multilayer structures 101 may include first to nth patterns stacked being spaced apart from each other on the substrate. n, as the number of stacked patterns, may be the number of layers in each of the multilayer structures 101 and may be an integer equal to or greater than 3. When the width W1 of the first pattern 12 is I, the width Wn of the nth pattern may be (2n−1)×I. The nth pattern may include edge parts disposed at both sides of the n−1th pattern and exposed by the n−1th pattern. The width of the exposed top surface of each of the edge parts may be I. The first pattern 12 of one among the plurality of multilayer structures 101 may be spaced by a P interval apart from the first pattern 12 of another multilayer structure 101 adjacent to the one. That is, the multilayer structures 101 may be spaced by the P interval from each other and disposed repeatedly. P may be n×I×2.

According to an embodiment of the inventive concept, as shown in

FIG. 1, in the case of each of the three story multilayer structures 101, it is confirmed that the width W2 of the second pattern 22 is 3×I and the width W3 of the third pattern 32 is 54 and also it is confirmed that the width of the top surface of each of the first edge parts 26 and the second edge parts 36 in the second pattern 22 and the third pattern 32 is uniform as I. Furthermore, it is confirmed that an interval between the plurality of multilayer structures 101 is 3×1×2=6I on the basis of each first pattern 12.

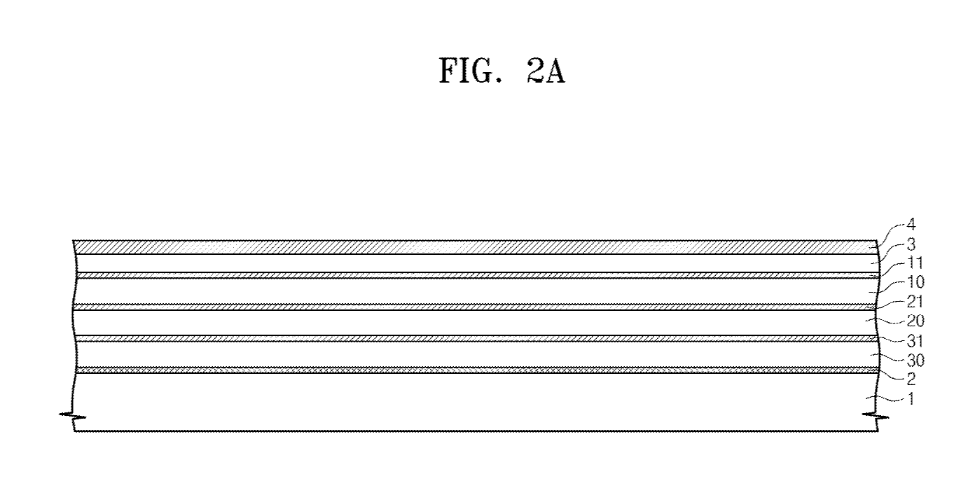

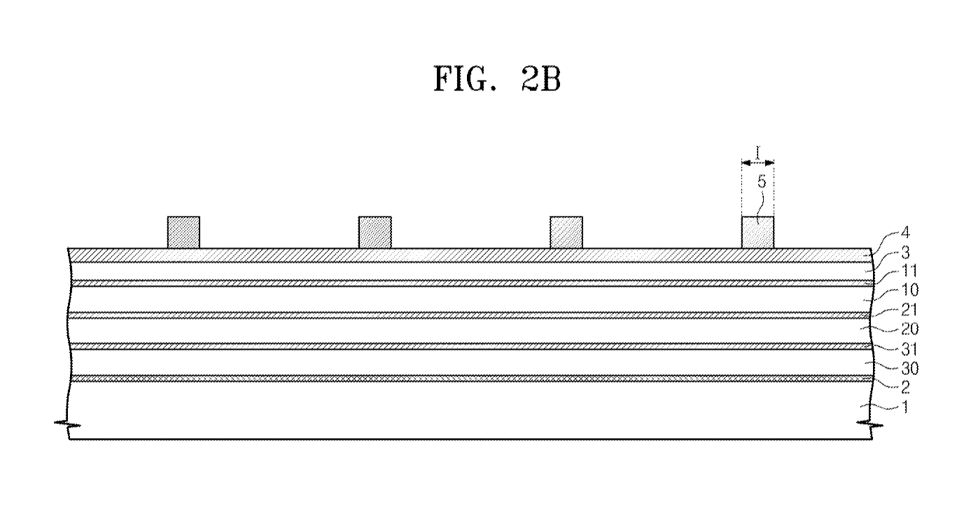

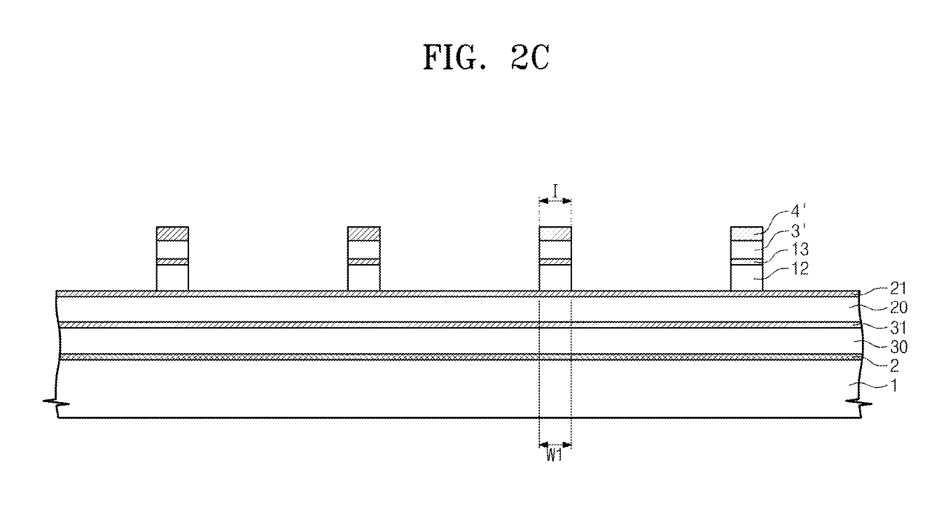

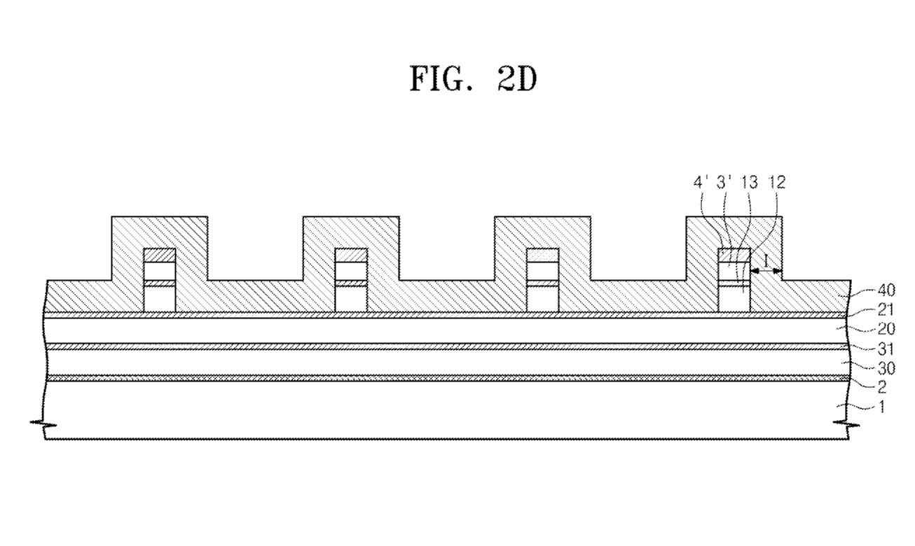

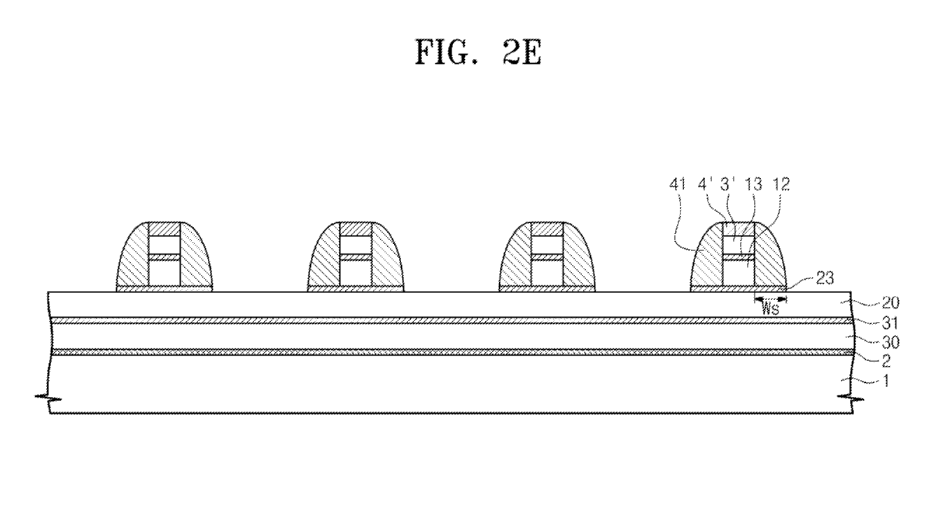

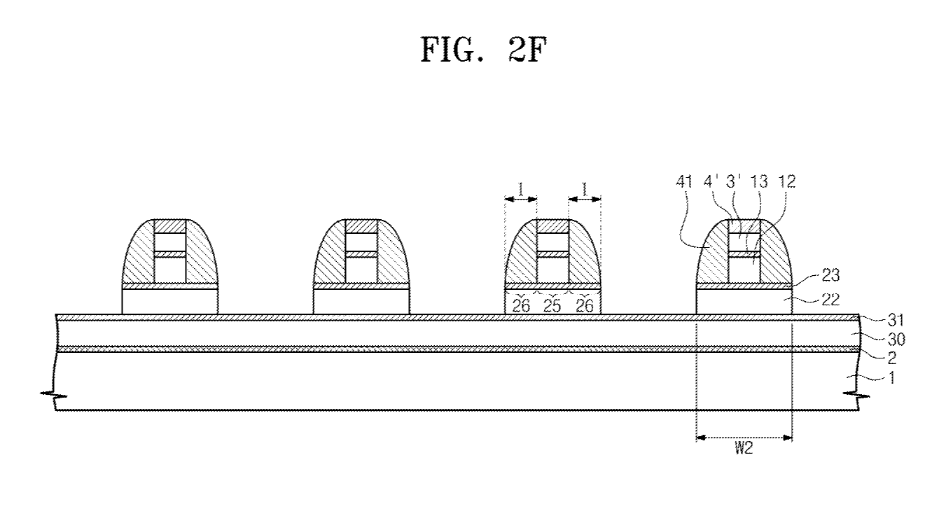

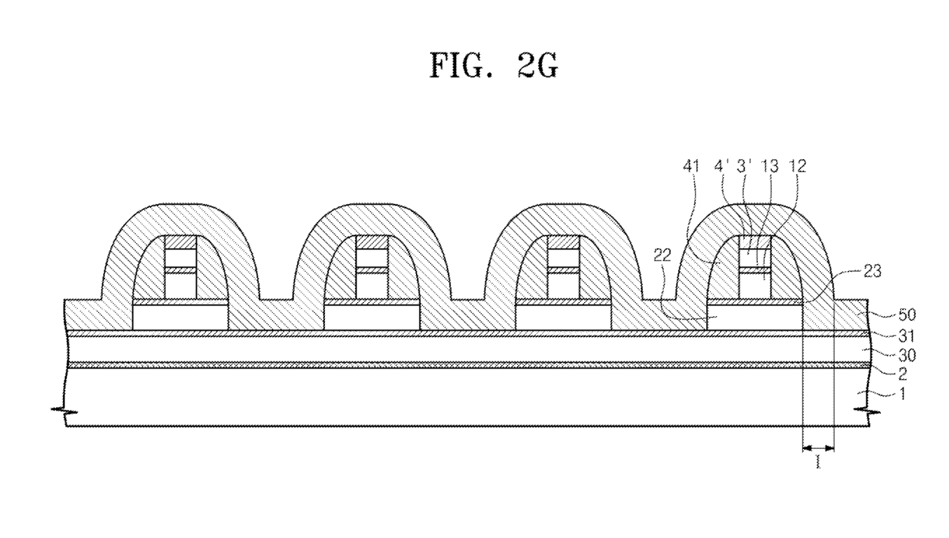

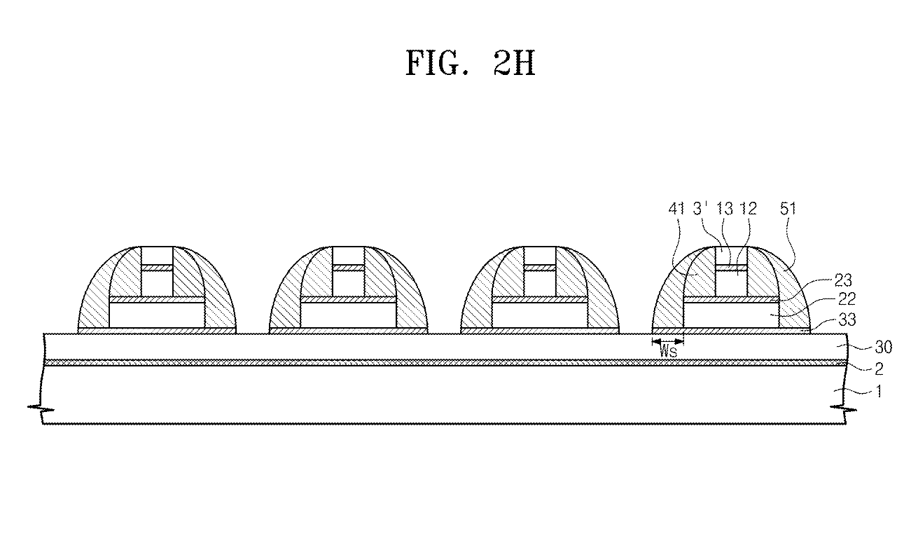

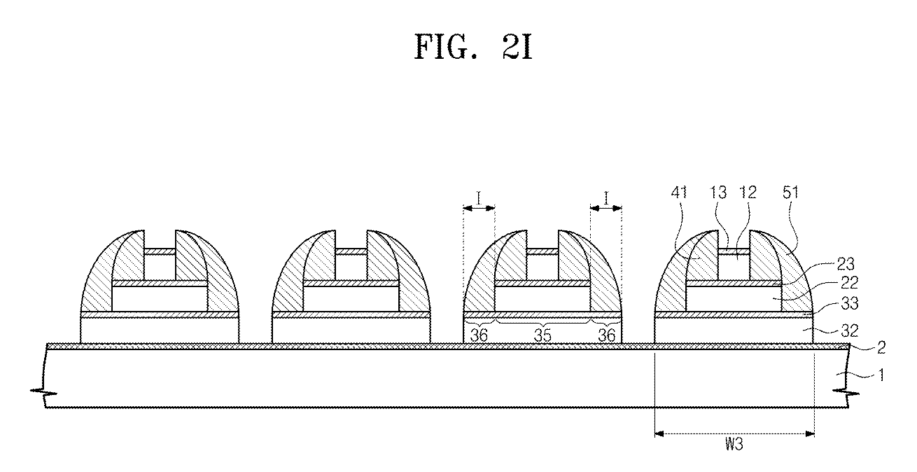

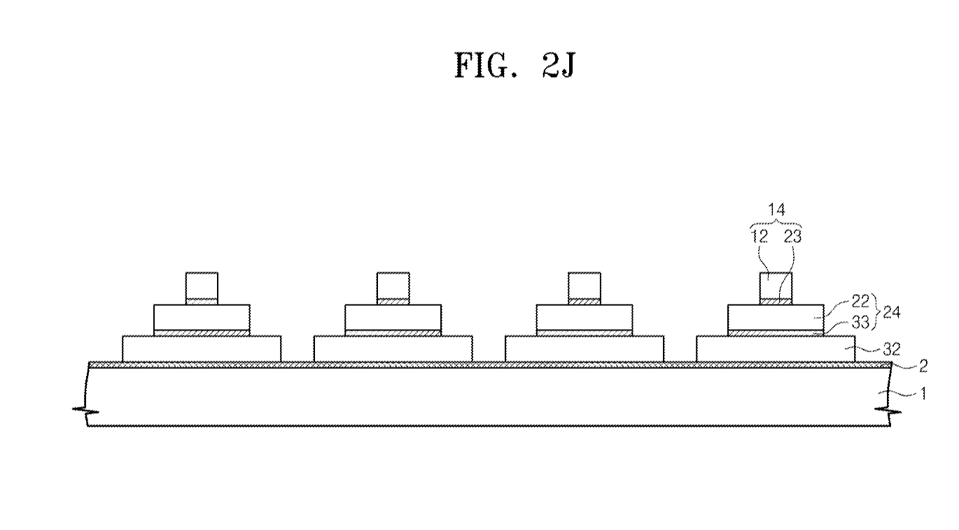

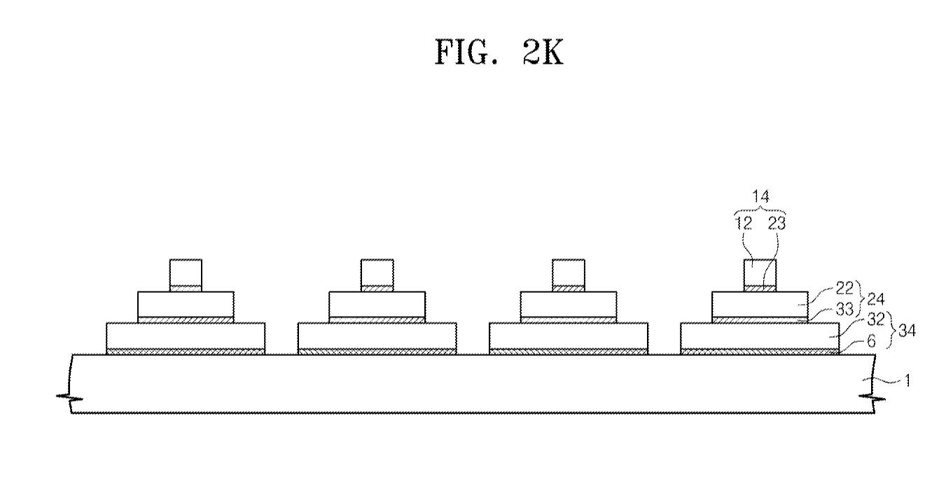

A method of fabricating the base mold 100 including 3 story (n=3) multilayer structures 101 shown in FIG. 1 is exemplarily described with reference to FIGS. 2A to 2K. The multilayer structures 101 may be more than a four-story multilayer structures by using a fabricating method described below and are not limited to three-story multilayer structure.

Referring to FIG. 2A, a first preliminary layer 10, a second preliminary layer 20, and a third preliminary layer 30, which are spaced apart from each other and stacked, may be formed on a substrate 1. The third preliminary layer 30 among the first preliminary layer 10, the second preliminary layer 20, and the third preliminary layer 30 may be disposed at the lowermost position. More particularly, the third preliminary layer 30 may be disposed between the first substrate 1 and the second preliminary layer 20 and may be disposed spaced from the first preliminary layer 10 with the second preliminary layer 20 therebetween.

The forming of the first preliminary layer 10, the second preliminary layer 20, and the third preliminary layer 30 may be performed through a general thin film deposition process but is not limited thereto.

The first preliminary layer 10, the second preliminary layer 20, and the third preliminary layer 30 may be formed of a silicon oxide layer, an amorphous silicon layer, or a silicon nitride layer but is not limited thereto. According to an embodiment of the inventive concept, the first preliminary layer 10, the second preliminary layer 20, and the third preliminary layer 30 may be a silicon oxide layer.

The substrate 1 may be a silicon substrate. For example, when the substrate 1 is a silicon substrate having a (100) crystal structure, a silicon etch stop layer 2 may be additionally formed between the substrate 1 and the third preliminary layer 30. The role of the silicon etch stop layer 2 will be described later.

As another example, when the substrate 1 is a silicon substrate having a (111) crystal structure, the forming of the silicon etch stop layer 2 may be omitted.

The silicon etch stop layer 2 may include a silicon oxide layer, an amorphous silicon layer, a silicon nitride layer, TiW, TiN, Ti, or Al but is not limited thereto. According to an embodiment of the inventive concept, the silicon etch stop layer 2 may be a silicon nitride layer.

The forming of the first preliminary layer 10, the second preliminary layer 20, and the third preliminary layer 30 may include additionally forming a first etch stop layer 11, a second etch stop layer 21, and a third etch stop layer 31. The first etch stop layer 11 may be disposed on the first preliminary layer 10. The second etch stop layer 21 may be disposed between the first preliminary layer 10 and the second preliminary layer 20. The third etch stop layer 31 may be disposed between the second preliminary layer 20 and the third preliminary layer 30.

The first etch stop layer 11, the second etch stop layer 21, and the third etch stop layer 31 may be formed of at least one of a silicon oxide layer, an amorphous silicon layer, a silicon nitride layer, TiW, TiN, Ti, and Al but is not limited thereto. In order to perform the role to prevent etching the first preliminary layer 10, the second preliminary layer 20, and the third preliminary layer 30, the first to third etch stop layers 11, 21, and 31 may be formed of an excellent etching selectivity with respect to those layers. In more detail, an etching selectivity of the first preliminary layer 10, the second preliminary layer 20 and the third preliminary layer 30, and an etching selectivity of the first etch stop layer 11, the second etch stop layer 21 and the third etch stop layer 31 may be more than 10:1. According to an embodiment of the inventive concept, if the first preliminary layer 10, the second preliminary layer 20, and the third preliminary layer 30 is a silicon oxide layer, the first etch stop layer 11, the second etch stop layer 21, and the third etch stop layer 31 may be an amorphous silicon.

The forming of the first preliminary layer 10, the second preliminary layer 20, and the third preliminary layer 30 may include forming additional etch stop layers 3 and 4 on the first preliminary layer 10. In more detail, the additional etch stop layers 3 and 4 may be directly formed on the first preliminary layer 10 but may be directly formed on the first etch stop layer 11 when the first etch stop layer 11 is formed already. Furthermore, the additional etch stop layers 3 and 4 may be formed of different materials.

The additional etch stop layers 3 and 4 may include a first additional etch stop layer 3 and a second additional etch stop layer 4. The first additional etch stop layer 3 and the second additional etch stop layer 4 may be formed of at least one of a silicon oxide layer, an amorphous silicon layer, a silicon nitride layer, TiW, TiN,

Ti, and Al but are not limited thereto. According to an embodiment of the inventive concept, the first additional etch stop layer 3 may be a silicon oxide layer and the second additional etch stop layer 4 may be an amorphous silicon layer. Furthermore, a thickness of the first additional etch stop layer 3 may be about 200 nm and a thickness of the second additional etch stop layer 4 may be about 350 nm. These thicknesses may be selected appropriately within a range not exposing the first pattern 12 but the inventive concept is not limited specifically.

Referring to FIG. 2B, a photoresist pattern 5 may be formed on the first preliminary layer 10 through a lithography process. According to an embodiment of the inventive concept, since the first etch stop layer 11, the first additional etch stop layer 3, and the second additional etch stop layer 4 are disposed on the first preliminary layer 10, the photoresist pattern 5 may be directly formed on the second additional etch stop layer 4.

The photoresist pattern 5 may be formed by using the mask 200 shown in FIG. 1. At this point, optical exposure equipment with excellent productivity (for example, a stepper and a scanner) may be used, or electron beam exposure equipment may be used. The photoresist pattern 5 may be formed to have a width I. Although not illustrated, a width of the chrome layer 201 of the mask 200 shown in FIG. 1 may be 41 to SI, when the photoresist pattern 5 is formed by using the optical exposure equipment. The photoresist pattern 5 having the width I may be formed by irradiating electron beam without the mask 200, when the electron beam exposure equipment is used.

Referring to FIG. 2C, a first pattern 12 may be formed by etching the first preliminary layer 10 by using the photoresist pattern 5 as an etching mask. The etching process may be a dry etching process. Furthermore, according to an embodiment of the inventive concept, a first etch stop pattern 13, a first additional etch stop pattern 3′, and a second additional etch stop pattern 4′ may be formed by patterning the first etch stop layer 11, the first additional etch stop layer 3, and the second additional etch stop layer 4 between the photoresist pattern 5 and the first preliminary layer 10 by using the photoresist pattern 5 as an etching mask.

The width W1 of the first pattern 12 may be I.

The forming of the first pattern 12 may additionally include removing the remaining photoresist pattern 5 after etching. The removing of the photoresist pattern 5 may be performed by wet removal using photoresist removal solution or dry removal using oxygen plasma.

Referring to FIG. 2D, a first spacer layer 40 may be formed on the first pattern 12. According to an embodiment of the inventive concept, the first spacer layer 40 may be formed to cover the sidewalls of the first pattern 12, the first etch stop pattern 13, the first additional etch stop pattern 3′, and the second additional etch stop pattern 4′.

The first spacer layer 40 may be a silicon oxide layer, an amorphous silicon layer, or a silicon nitride layer but is not limited thereto. The first spacer layer 40 may be used as a mask for etching the second preliminary layer 20. Accordingly, an etching selectivity of the second preliminary layer 20 and the first spacer layer 40 may be more than 10:1. According to an embodiment of the inventive concept, the first spacer layer 40 may be an amorphous silicon layer.

When the width W1 of the first pattern 12 is I, the first spacer layer 40 may be deposited with a thickness of 0.9I to 1.1I. For example, the first spacer layer 40 may be deposited with a thickness of I. The multilayer structure 101 is formed to allow the top surface of each edge part exposed to the outside to have a width identical to W1, so that a pattern having a uniform width may be provided. Accordingly, by adjusting a deposition thickness of the first spacer layer 40 to have 0.9I to 1.1I, so that the width of the top surface of each first edge part 26 of a second pattern 22 described later may be I. That is, without the need for complex and precise operations, the second pattern 22 having a desired width may be formed by adjusting a deposition thickness of the first spacer layer 40.

Referring to FIG. 2E, a first spacer 41 may be formed on both sidewalls of the first pattern 12 by blanket-etching the first spacer layer 40. The blanket etching may be a dry etching process. The top surface of the second additional etch stop pattern 4′ may be exposed by the dry etching process. The first spacer 41 may have a width Ws in a direction vertical to the sidewall of the first pattern 12. The width Ws of the first spacer 41 may be identical to the width W1 of the first pattern 12. This may be implemented by adjusting the degree of over etch during a blanket dry etching process of the first spacer layer 40 from a deposition thickness (0.9I to 1.1I) of the first spacer layer 40. Then, the first spacer 41 may be used for forming the second pattern 22 below the first pattern 12. Furthermore, the etching of the first spacer layer 40 may form a second etch stop pattern 23 by etching the second etch stop layer 21 simultaneously. Accordingly, part of the top surface of the second preliminary layer 20 may be exposed.

Referring to FIG. 2F, a second pattern 22 may be formed by etching the second preliminary layer 20 by using the first spacer 41 as an etching mask. The etching process of the second preliminary layer 20 may be a dry etching process. At this point, the second additional etch stop pattern 4′ may prevent the first pattern 12 from being etched.

The width Ws of the first spacer 41 may be I and accordingly, the width W2 of the second pattern 22 formed by using the first spacer 41 as a mask may be 34. Furthermore, a width of the top surface of the first edge part 26 of the second pattern 22 may be I.

Referring to FIG. 2G, a second spacer layer 50 may be formed on the first pattern 12 and the second pattern 22. According to an embodiment of the inventive concept, the second spacer layer 50 may be formed to cover the sidewalls of the first spacer 41, the sidewalls of the second pattern 22, and the top surface of the third etch stop layer 31.

The second spacer layer 50 may be a silicon oxide layer, an amorphous silicon layer, or a silicon nitride layer but is not limited thereto. The second spacer layer 50 may be used as a mask for etching the third preliminary layer 30. Accordingly, an etching selectivity of the third preliminary layer 30 and the second spacer layer 50 may be more than 10:1. According to an embodiment of the inventive concept, the second spacer layer 50 may be an amorphous silicon layer.

Like the first spacer layer 40, when the width W1 of the first pattern 12 is I, the second spacer layer 50 may be deposited with a thickness of 0.9I to 1.1I. For example, the first spacer layer 40 may be deposited with a thickness of I. This is to form a third pattern 32 having a desired width as in the case of the second pattern 22.

Referring to FIG. 2H, a second spacer 51 may be formed on both sidewalls of the second pattern 22 by blanket-dry-etching the second spacer layer 50. The top surface of the first additional etch stop pattern 3′ may be exposed by etching the second additional etch stop pattern 4′ through the dry etching process. The second spacer 51 may have a width Ws in a direction vertical to the sidewall of the second pattern 22. The width Ws of the second spacer 51 may be identical to the width W1 of the first pattern. This may be implemented by adjusting the degree of over etch during a blanket-dry-etching process of the second spacer layer 50 from a deposition thickness (0.9I to 1.1I) of the second spacer layer 50. Furthermore, the etching of the second spacer layer 50 may form a third etch stop pattern 33 by etching the third etch stop layer 31 simultaneously. Accordingly, part of the top surface of the third preliminary layer 30 may be exposed.

Referring to FIG. 21, a third pattern 32 may be formed by etching the third preliminary layer 30 by using the second spacer 51 as an etching mask. The etching process of the third preliminary layer 30 may be a dry etching process. At this point, an etching selectivity of the third preliminary layer 30 and the silicon etch stop layer 2 may be more than 10:1 (for example, the silicon etch stop layer is a silicon nitride layer), so that this may prevent the substrate 1 from being etched. Furthermore, the first additional etch stop pattern 3′ may be etched simultaneously as the third preliminary layer 30 is etched but the first etch stop pattern 13 may prevent the first pattern 12 from being etched.

The width Ws of the second spacer 51 may be I and accordingly, the width W3 of the third pattern 32 formed by using the second spacer 51 as a mask may be 5×I. Furthermore, a width of the top surface of the second edge part 36 of the third pattern 32 may be I. As a result, in the plane view, the first pattern 12, the second pattern 22, and the third pattern 32 may form a uniform grating pattern having a width of I.

Referring to FIG. 2J, the first spacer 41 and the second spacer 51 may be removed simultaneously. Process simplification may be achieved by removing the spacers 41 and 51 simultaneously. The removing of the first spacer 41 and the second spacer 51 may be performed through a wet etching process. A KOH solution may be used as an etching solution but the inventive concept is not limited thereto. As the first spacer 41 and the second spacer 51 are removed, the first etch stop pattern 13 may be removed together. Furthermore, parts of the second etch stop pattern 23 and the third etch stop pattern 33 may be removed together but a portion contacting a lower part of each of the first pattern 12 and the second pattern 22 may be preserved by adjusting an etching process. For example, an etching amount may be adjusted by adjusting an etching time.

For example, when the substrate 1 is a silicon substrate having a (100) crystal structure, as the first spacer 41 and the second spacer 51 are removed simultaneously, the silicon etch stop layer 2 may prevent the silicon substrate 1 from being etched.

As another example, when the substrate 1 is a silicon substrate having a (111) crystal structure, since an etching selectivity of the silicon substrate with respect to an etching solution (for example, KOH) is low, the substrate 1 is not etched. Accordingly, in this case, the forming of the silicon etch stop layer 2 may be omitted.

Furthermore, in forming the above-described additional etch stop layers 3 and 4, the additional etch stop layers 3 and 4 may be appropriately formed according to a method of fabricating the base mold 100 and a material used for forming it. For example, in the case that the first and second spacer layers 40 and 50 and the first to third etch stop layers 11, 21, and 31 are formed of the same layer, when the first spacer 41 and the second spacer 51 are formed by etching the first spacer 40 and the second spacer layer 50 and when the second pattern 22 and the third pattern 32 are formed by using the first spacer 41 and the second spacer 51 as an etching mask, the first pattern 12, i.e., the top layer part of the multilayer structure 101, may be exposed and etched. Accordingly, in order to resolve such an issue, the additional etch stop layers 3 and 4 may be formed. According to an embodiment of the inventive concept, the first additional etch stop layer 3 and the second additional etch stop layer 4 may be sequentially formed on the first etch stop layer 11.

Referring to FIG. 2K, a silicon etch stop pattern 6 may be formed by etching an exposed portion of the silicon etch stop layer 2. The etching process may be a dry etching process. As a result, prepared is a base mold 100 including a plurality of multilayer structures 101 arranged to be spaced apart from each other in one direction on the substrate 1. The multilayer structure 101 may include: a first layer 14 including the first pattern 12 and the second etch stop pattern 23; a second layer 24 including the second pattern 22 and the third etch stop pattern 33; and a third layer 34 including the third pattern 32 and the silicon etch stop pattern 6.

According to an embodiment of the inventive concept, an entire height of each of the multilayer structures 101 and each height of the first layer 14, the second layer 24, and the third layer 34 constituting the multilayer structure 101 may be determined by adjusting the deposition thicknesses of the first to third preliminary layers 10, 20, and 30, the first to third additional etch stop layers 11, 21, and 31, and the silicon etch stop layer 2. According to an embodiment of the inventive concept, a height of each of the first layer 14, the second layer 24, and the third layer 34 may be adjusted to about 500 nm. For this, a deposition thickness of each of the first preliminary layer 10, the second preliminary layer 20, and the third preliminary layer 30 may be about 450 nm. A deposition thickness of each of the first etch stop layer 11, the second etch stop layer 21, and the third etch stop layer 31 may be about 50 nm. A deposition thickness of the silicon etch stop layer 2 may be about 50 nm.

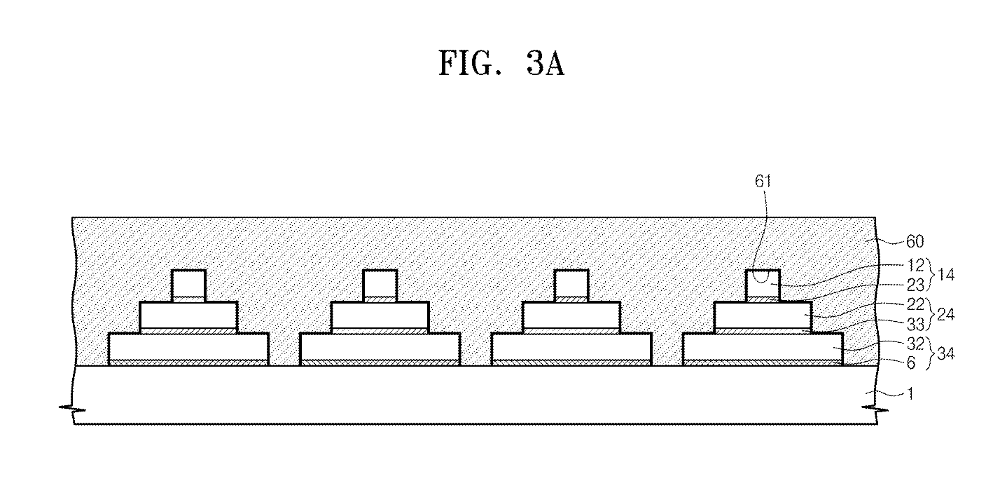

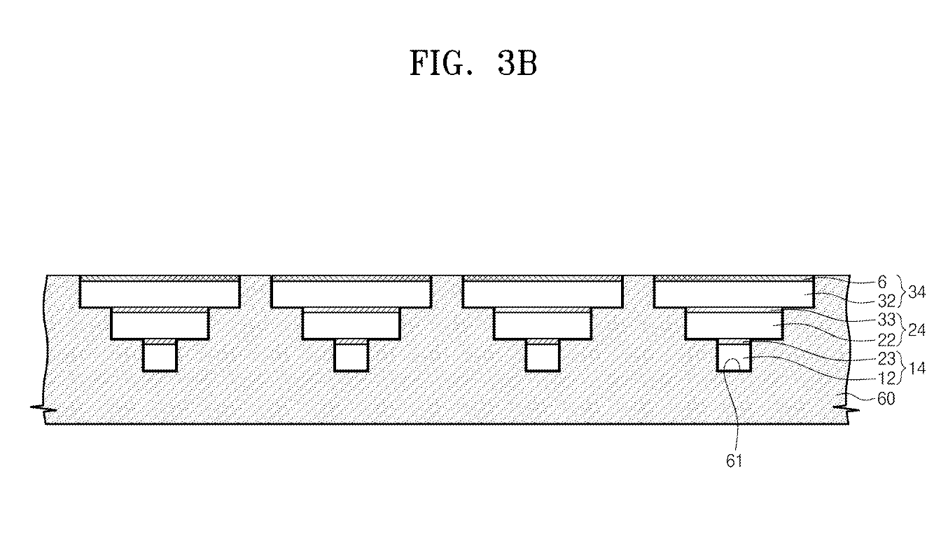

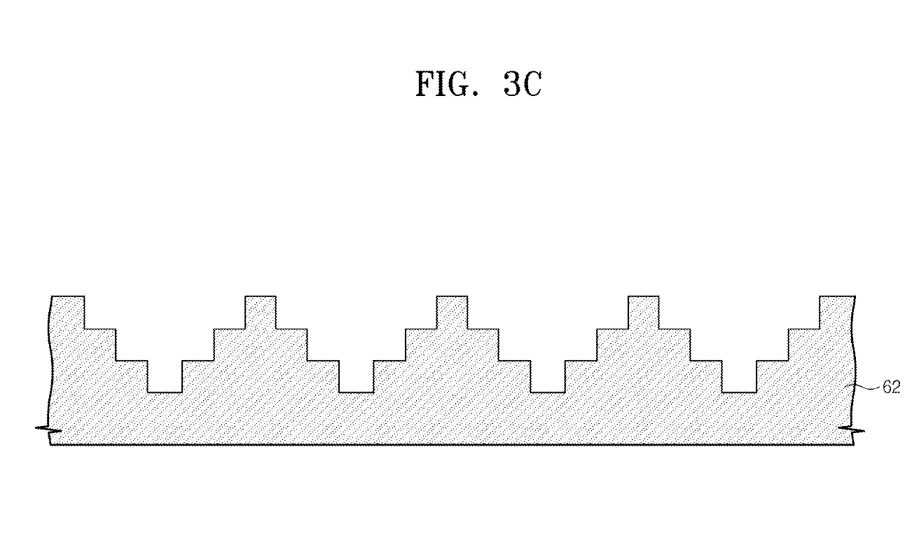

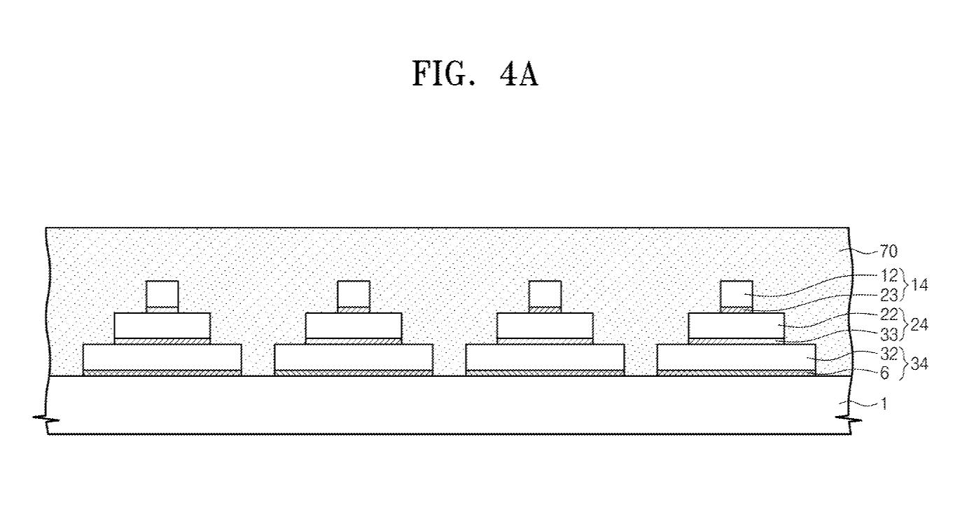

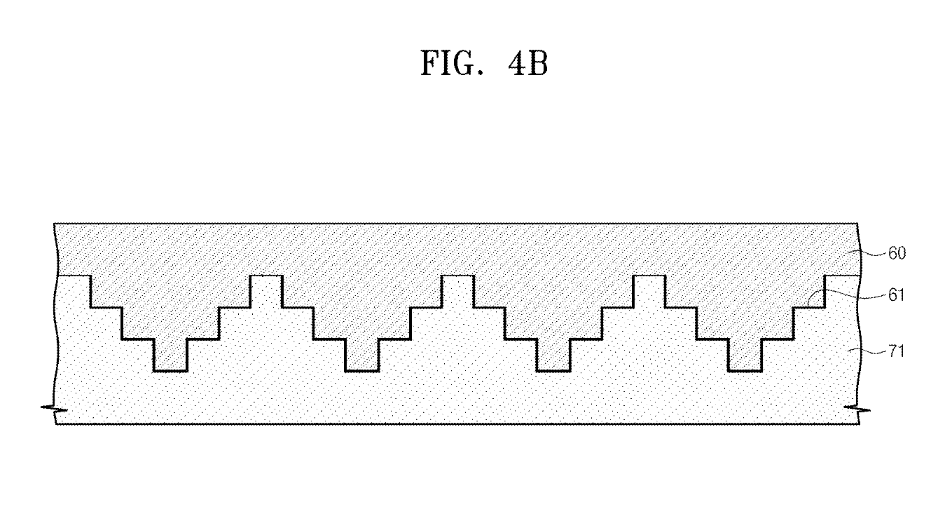

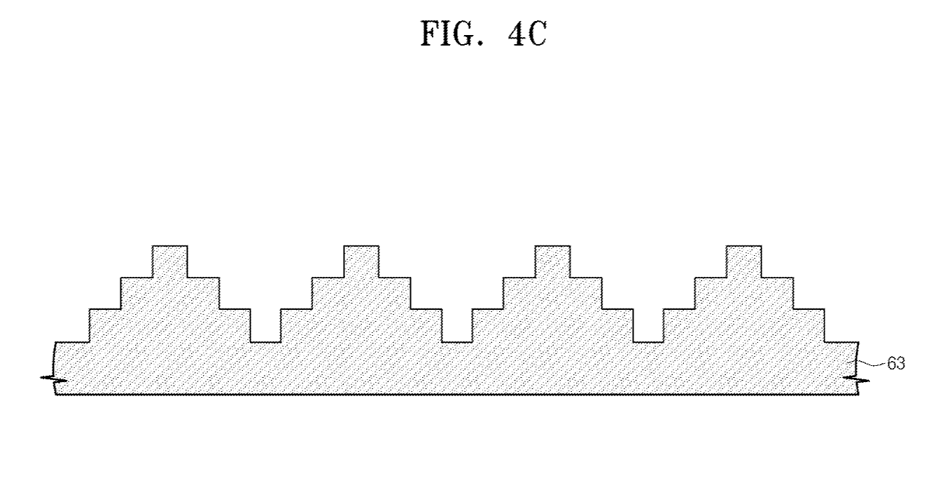

Hereinafter, a method of fabricating a mold for plastic injection molding and structural color implementation by using the base mold 100 including the multilayer structures 101 shown in FIG. 1 may be described exemplarily with reference to FIGS. 3A to 3C and 4A to 4C.

As the case that the substrate 1 is a silicon substrate having a (100) crystal structure, FIGS. 3A to 3C illustrate a method of fabricating a metal mold 62 when the substrate 1 is removable through wet etching. At this point, the metal mold 62 may be shown in a form in which the surface structures of the multilayer structures 101 are phase-inverted and transferred.

Referring to FIG. 3A, a metal mold layer 60 may be formed by introducing metal to the multilayer structures 101. In more detail, the forming of the metal mold layer 60 may include forming a seed layer 61 on the multilayer structures 101 and plating a metal. The forming of the seed layer 61 may include forming a contact enhancement layer additionally but is not limited thereto. The metal may be plated in a form grown on the basis of the seed layer 61.

According to an embodiment of the inventive concept, the metal may be Ni and may be plated at a thickness of about 3 μm.

Referring to FIG. 3B, the substrate 1 may be removed. The removing of the substrate 1 may be removed through wet etching and may use a KOH solution as an etching solution. As the case that the substrate 1 is a silicon substrate having a (100) crystal structure, the substrate 1 may be removed easily through wet etching.

Referring to FIG. 3C, the metal mold 62 may be obtained by removing the multilayer structures 101. The removing of the multilayer structures 101 may be performed through wet etching and may use a hydrofluoric acid solution (BHF 6:I) as an etching solution.

The obtained metal mold 62 is obtained by directly transferring the surface structures of the multilayer structures 101 and thus may have an opposite phase to the multilayer structure 101.

As the case that the substrate 1 of the base mold 100 is a silicon substrate having a (111) crystal structure, FIGS. 4A to 4C illustrate a method of fabricating a mold when the substrate 1 is not removable through wet etching. At this point, a mold may be formed as a mold layer by using a thermosetting resin (for example, polydimethylsiloxane (PDMS)). When a thermosetting resin is used, the base mold 100 may be easily separated from the mold layer. Furthermore, forming a metal mold 63 is additionally included finally by introducing a metal to a formed resin mold 71. In this case, the metal mold 63 may be shown in a form in which the surface structures of the multilayer structures 101 of the base mold 100 are transferred with the same phase.

Referring to FIG. 4A, a resin mold layer 70 may be formed by introducing a thermosetting resin to the multilayer structures 101. In more detail, the resin mold layer 70 may be formed by applying a release agent and a thermosetting resin on the multilayer structures 101 and then performing thermal treatment and UV curing processes.

According to an embodiment of the inventive concept, the thermosetting resin may be PDMS(polydimethylsiloxane) but is not limited thereto.

Referring to FIG. 4B, a metal mold layer 60 may be formed by separating the substrate 1 and the multilayer structures 101 from the resin mold layer 70 and then introducing a metal to the resin mold layer 70. In more detail, the forming of the metal mold layer 60 may include forming a seed layer 61 on the resin mold layer 70 and plating a metal. The forming of the seed layer 61 may include forming a contact enhancement layer additionally but is not limited thereto. The metal may be plated in a form grown on the basis of the seed layer 61.

According to an embodiment of the inventive concept, the metal may be Ni and may be plated at a thickness of about 3 μm.

Referring to FIG. 4C, a metal mold 63 may be obtained by separating the resin mold layer 70 plated metal from the metal mold layer 60.

Unlike the metal mold 62 described with reference to FIG. 3, the obtained metal mold 63 may be indirectly transferred through a resin mold as an intermediate and thus may have the same phase as the multilayer structures 101.

According to an embodiment of the inventive concept, by forming a base mold including multilayer structure on a substrate through a semiconductor process, the width, height, and interval of patterns constituting the multilayer structures may be adjusted easily and especially a grating pattern of a multilayer structure may be formed. With a simple process simultaneously, the multilayer structures may be fabricated to have a high implementing characteristic.

Accordingly, a mold for plastic injection molding and structural color implementation obtained through the base mold has a pattern of a multilayer structure that is repeated periodically from the plane viewpoint and may implement structural color on a plastic surface effectively. Or, since the width, height, interval, and layer of a pattern constituting the multilayer structures are easily changed during a fabricating process, a mold of various structural colors may be provided.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A base mold comprising:
a plurality of multilayer structures arranged to be spaced apart from each other in one direction on a substrate,
wherein
each of the multilayer structures comprises first to nth patterns spaced apart from each other and sequentially stacked on the substrate;
a width of the first pattern is I;
a width of the nth pattern is (2n−1)×I;
the nth pattern includes edge parts disposed at both sides of the n−1th pattern and exposed by the n−1th pattern;
a width of a top surface of each of the edge parts is I; and
the first pattern of any one multilayer structure is spaced by a P interval apart from the first pattern of adjacent another multilayer structure, wherein P is n×I×2 and n is an integer equal to or greater than 3.

2. A method of fabricating a mold, the method comprising:
forming a first preliminary layer, a second preliminary layer, and a third preliminary layer disposed between the substrate and the second preliminary layer and spaced apart from the first preliminary layer with the second preliminary layer therebetween, which are spaced apart from each other and stacked on a substrate;
forming a first pattern by patterning the first preliminary layer;
forming a first spacer on both sidewalls of the first pattern;
forming a second pattern by etching the second preliminary layer by using the first spacer as an etching mask;
forming a second spacer on both sides of the second pattern;
forming a third pattern by etching the third preliminary layer by using the second spacer as an etching mask;
forming a multilayer structure including the first pattern, the second pattern and the third pattern on the substrate by removing the first spacer and the second spacer simultaneously; and
forming a mold layer covering the multilayer structure.

3. The method of claim 2, wherein
a width of the first pattern is I;
a width of the second pattern is 3×I;
a width of the third pattern is 5×I; and
the second pattern comprises first edge parts disposed at both sides of the first pattern and exposed by the first pattern,
the third pattern comprises second edge parts disposed at both sides of the second pattern and exposed by the second pattern,
wherein a width of a top surface of each of the first edge parts and the second edge parts is I.

4. The method of claim 2, wherein the multilayer structure is formed repeatedly and the first pattern is spaced by a P interval apart from the first pattern of adjacent another multilayer structure,
wherein P is (n)×I×2, n=the number of stacked patterns, I=a width of the first pattern.

5. The method of claim 2, wherein the forming of the first, second and third preliminary layers comprises additionally forming a first etch stop layer disposed on the first preliminary layer, a second etch stop layer disposed between the first preliminary layer and the second preliminary layer, and a third etch stop layer disposed between the second preliminary layer and the third preliminary layer.

6. The method of claim 2, wherein the substrate is a silicon substrate having a (100) crystal structure and the forming of the first, second and third preliminary layers comprises additionally forming a silicon etch stop layer on the substrate.

7. The method of claim 2, wherein the forming of the first pattern comprises:
forming a photoresist pattern having a width of I on the uppermost part of the substrate in a direction where the first and second preliminary layers are disposed; and
forming the first pattern by etching the first preliminary layer by using the photoresist pattern as an etching mask.

8. The method of claim 2, wherein a width of the first pattern is I, wherein
the forming of the first spacer comprises:
depositing a first spacer layer on the first pattern at a thickness of 0.9I to 1.1I; and
forming a first spacer on both sidewalls of the first pattern by etching the first spacer layer, the first spacer having a width of I in a direction vertical to a sidewall of the first pattern.

9. The method of claim 8, wherein a width of the second pattern is 3I, wherein
the forming of the second spacer comprises:
depositing a second spacer layer on the first and second patterns at a thickness of 0.9I to 1.1I; and
forming a second spacer on both sidewalls of the second pattern by etching the second spacer layer, the second spacer having a width of I in a direction vertical to a sidewall of the second pattern.

10. The method of claim 2, wherein the substrate is a silicon substrate having a (100) crystal structure,
wherein
the forming of the mold layer comprises:
forming a metal mold layer by introducing a metal to the multilayer structure; and
removing the substrate and the multilayer structure.

11. The method of claim 2, wherein the substrate is a silicon substrate having a (111) crystal structure,
wherein the forming of the mold layer comprises:
forming a resin mold layer by introducing a thermosetting resin to the multilayer structure; and
separating the substrate and the multilayer structure from the resin mold layer.
